(19) United States
(12) Patent Application Publication
(10) Pub. No.: US 2023/0232846 A1
(43) Pub. Date: Jul. 27, 2023

(54) FOOD SMOKING DEVICE

(71) Applicant: WHIRLPOOL CORPORATION, BENTON HARBOR, MI (US)

(72) Inventors: Giovanni Paolo Biscottini, Pero (IT); Holly Day, Elkhart, IN (US); Francesco DelTorto, Pero (IT); Riccardo Loner, Busto Arsizio (IT); Michele Ann Paustian, Saint Joseph, MI (US)

(73) Assignee: WHIRLPOOL CORPORATION, BENTON HARBOR, MI (US)

(21) Appl. No.: 17/584,953

(22) Filed: Jan. 26, 2022

(51) Int. Cl. A23B 4/052

(52) U.S. Cl. CPC A23B 4/052

(57) ABSTRACT

A food smoking device is provided and includes a housing removably disposed within an oven; a heater disposed within the housing; and a container disposed on the heater. The container receives wood or coal pellets, and a lid of the container is perforated. The housing defines a smoke-collecting chamber therein. The smoke-collecting chamber receives, via the perforated lid of the container, smoke generated from heated wood or coal pellets. The smoke-collecting chamber fluidly communicates with a cooking chamber of the oven via an opening defined in the housing and supplies the generated smoke into the cooking chamber. Further, a suction fan is disposed within the housing to selectively extract smoke into the smoke-collecting chamber.

### TECHNICAL FIELD

The present disclosure relates, in general, to smoking devices. More specifically, the present disclosure relates to a food smoking device for an oven that imparts flavor to food items being cooked within an oven cavity.

### BACKGROUND

Typically, food smoking is a process of imparting flavor to food items by exposing the food items to smoke that is generated from burning or smoldering of commonly used fuel materials such as wood, charcoal, propane, and the like. For example, wood materials, such as wood from oak trees, maple trees, apple trees, plum trees, and the like, may be used as prevalent fuel materials to add flavor to the food items.

Known smoking devices are usually large in size and demand large space in an oven cavity. Smoke produced by such smoking devices are not controlled and hence produce smoke clouds inside the oven cavity, which creates discomfort to users accessing the oven cavity after a cooking cycle is completed. Such smoke clouds may take a while to get cleared from the oven cavity before the user can locate the food items.

U.S. Pat. No. 10,264,802 discloses a flavoring device associated with a cooking chamber of a cooking oven and a method of controlling the flavoring device. U.S. Pat. No. 8,304,697 discloses a smoker device that fits beneath a lower-most rack of the cooking oven. However, these devices do not disclose any feature to eliminate the smoke clouds within the oven cavity.

### SUMMARY

According to one aspect of the present disclosure, a food smoking device for an oven is disclosed. The food smoking device includes a housing defining an opening and removably disposed within the oven. The food smoking device further includes a heater disposed within the housing and a container removably disposed on the heater, where the container receives wood or coal pellets, and a lid thereof is perforated. The housing defines a smoke-collecting chamber therein. The smoke-collecting chamber receives, via the perforated lid of the container, smoke generated from heated wood or coal pellets. Further, the smoke-collecting chamber fluidly communicates with a cooking chamber of the oven via the opening of the housing and supplies the generated smoke into the cooking chamber. The food smoking device further includes a suction fan disposed within the housing to selectively extract smoke into the smoke-collecting chamber.

In an embodiment, the food smoking device further includes a pipe extending from a periphery of the opening in the housing. The pipe routes the smoke from the smoke-collecting chamber to the cooking chamber. In an embodiment, the heater is powered by an in-oven plug.

According to the present disclosure, advantageously, the smoke generated from the heated wood or coal pellets is collected in the smoke-collecting chamber and is supplied to the cooking chamber of the oven via the pipe. As such, a controlled flow of smoke from the smoke-collecting chamber to the cooking chamber may be achieved. Further, advantageously, the suction fan selectively extracts the smoke into the smoke-collecting chamber based on the cooking cycle. As such, based on completion of the cooking cycle, the suction fan is actuated to extract the smoke from the cooking chamber of the oven, thereby eliminating presence of smoke clouds within the cooking chamber, and enhancing user convenience.

These and other aspects and feature of non-limiting embodiments of the present disclosure will become apparent to those skilled in the art upon review of the following description of specific non-limiting embodiments of the disclosure in conjunction with the accompanying drawings.

### BRIEF DESCRIPTION OF THE DRAWINGS

A better understanding of embodiments of the present disclosure (including alternatives and/or variations thereof) may be obtained with reference to the detailed description of the embodiments along with the following drawings, in which:

FIG. 1 is a perspective view of an exemplary oven, according to an embodiment of the present disclosure;

FIG. 2A is an exemplary cross-sectional view of the oven showing a food smoking device, according to an embodiment of the present disclosure;

FIG. 2B is a perspective view of a heater of the food smoking device, according to an embodiment of the present disclosure; and

FIG. 2C is a perspective view of a container of the food smoking device, according to an embodiment of the present disclosure.

### DETAILED DESCRIPTION

Reference will now be made in detail to specific embodiments or features, examples of which are illustrated in the accompanying drawings. Wherever possible, corresponding, or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

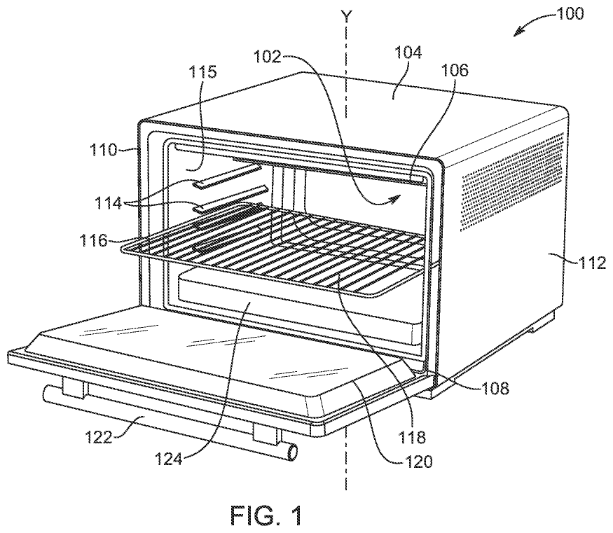

Referring to FIG. 1, an exemplary oven 100 is illustrated. The oven 100 defines a cooking chamber 102 configured to accommodate foodstuffs to be cooked in various cooking modes, for example, but not limited to, full cook, bake cook, and broil cook. A cabinet of the oven 100 functions as an insulating housing to maintain a desired temperature in the cooking chamber 102. Specifically, the oven 100 includes a top wall 104 housing a heater 106, a bottom wall 108, and a pair of side walls extending between the top wall 104 and the bottom wall 108, which together constitute the cabinet. A plurality of supports 114 extend from inner surfaces 115 of a first wall 110 and a second wall 112, respectively, and are configured to locate multiple racks at desired heights along a vertical axis “Y” of the oven 100. Each rack, such as the rack 116, includes a plurality of ribs 118. Further, a door 120 is hinged to the bottom wall 108 and configured to selectively close an access opening of the oven 100. A handle 122 attached to the door 120 defines, for example, a gripping portion for a user to move the door from an open position to a closed position. In an aspect, the oven 100 houses a food smoking device 124 on the bottom wall 108 thereof.

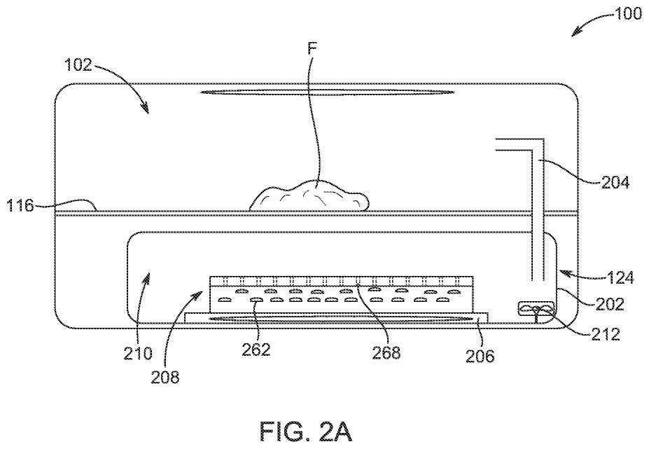

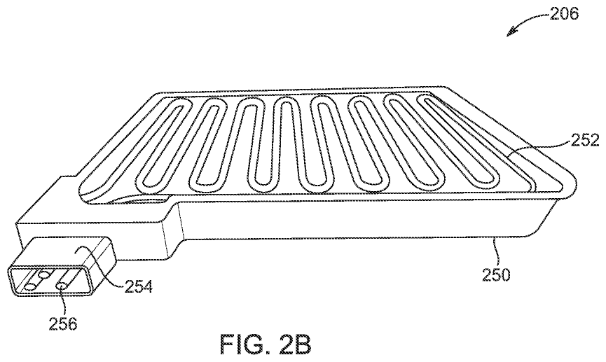

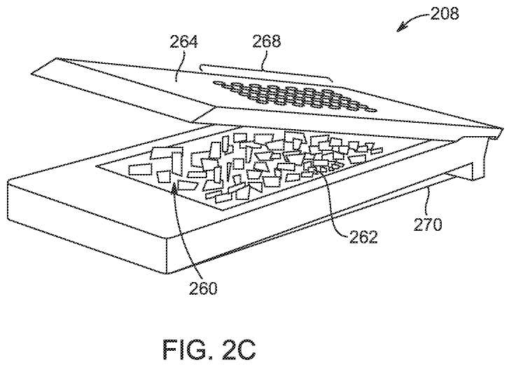

Referring to FIG. 2A, an exemplary cross-sectional view of the oven 100 is illustrated. The food smoking device 124 is removably disposed on the bottom wall 108 of the oven 100. Although the present disclosure considers a free-standing domestic oven, it is contemplated that the aspects of the present disclosure may be implemented within built-in ovens. The food smoking device 124 includes a housing 202 embodied as a hollow rectangular box with rounded corners and made of a heat-resistant material. Dimensions of the housing 202 may be predetermined such that the food smoking device 124 may be removably disposed underneath a bottom-most rack without contacting the inner surfaces 115 of the oven 100. In some embodiments, the food smoking device 124 may be disposed on any rack of the oven 100. As such, a height of the food smoking device 124 may be predefined to allow disposal thereof between two consecutive racks in, for example, a professional oven.

In an aspect, the housing 202 defines an opening (not particularly indicated in FIG. 2A), preferably at a top portion thereof. A pipe 204 of the food smoking device 124 extends from a periphery of the opening. In some embodiments, the pipe 204 may be detachably coupled to the periphery of the opening. In one example, the pipe 204 may be threadably coupled to the periphery of the opening. Such detachable configuration of the pipe 204 may ease the installation of the food smoking device 100 with minimum human effort. In another example, the pipe 204 may be partially inserted into the housing 202 via the opening and may be welded along the periphery of the opening, such that the housing 202 and the pipe 204 together constitutes a single component. Such configuration of the food smoking device 124 may enhance user convenience with reduced efforts with respect to installing the food smoking device 124 within the oven 100.

Preferably, the pipe 204 extends through the rack 116 in a vertical manner. For example, a gap defined between the ribs 118 of the rack 116 may direct the pipe 204 therethrough. In cases where the rack 116 defines small gap between the ribs 118 thereof, the rack 116 may define an aperture (not shown) to allow the pipe 204 to extend therethrough. Such aperture may help the user, for example, in aligning the food smoking device 124 within the cooking chamber 102. For example, the aperture may indicate to the user that the food smoking device 124 should be oriented in a manner such that the aperture is proximal to the access opening of the oven 100, so that the user may couple the pipe 204 to the housing 202 without having to insert hands further into the cooking chamber 102. In some embodiments, the rack 116 may define a slit to allow easy placement of the food smoking device 124 within the cooking chamber 102 in cases where the pipe 204 is integral to the housing 202. That is, with the single component configuration of the housing 202 and the pipe 204, the slit defined in the rack 116 may help align the pipe 204 with the rack 116 followed by a push of the food smoking device 124 into the cooking chamber 102, to achieve proper placement thereof. In some embodiments, inner surfaces of the housing 202 and the pipe 204 may be coated with a heat insulation material that is also fire resistant. In some embodiments, two or more pipes may be coupled to the housing 202.

The food smoking device 124 further includes a heater 206 and a container 208 disposed within the housing 202. With such arrangement, the housing 202 defines a smoke-collecting chamber 210 therein. A volume remaining within the housing 202 after disposing the heater 206 and the container 208 therein may define the smoke-collecting chamber 210. As such, volume of the smoke-collecting chamber 210 may be determined based on size of the heater 206 and the container 208. With such construction, the pipe 204 fluidly connects the smoke-collecting chamber 210 and the cooking chamber 102 of the oven 100. As used herein, the term “fluidly connects” refers to a channel through which fluids, such as air and smoke, are allowed to flow between the smoke-collecting chamber 210 and the cooking chamber 102. In some embodiments, the housing 202 may include a door (not shown) that allows selective access to the hollow space therein. With aid of such door, the heater 206 and the container 208 may be removably disposed within the housing 202. In one embodiment, the heater 206 may be integral to the housing 202 and the container 208 may be selectively disposed on the heater 206 when the food smoking device 124 needs to be put in use. As used herein, the term “selectively disposed” refers to locating and positioning the container 208 within the housing 202 at user's convenience.

Advantageously, the food smoking device 124 further includes a suction fan 212 disposed within the housing 202. Preferably, the suction fan 212 is located proximal to the opening defined in the housing 202. Particularly, the suction fan 212 is positioned within the housing 202, such that operation of the suction fan 212 can suction air from the cooking chamber 102 into the smoke-collecting chamber 210. The suction fan 212 may be integral to the housing 202 and may be powered through a main electrical input (not shown) provided in the housing 202. Further, operation of the suction fan 212 may be controlled by a controller (not shown) of the oven 100 when the food smoking device 124 is operably disposed within the cooking chamber 102. As such, the suction fan 212 may not begin to operate soon after the oven 100 is powered on.

FIG. 2B illustrates a perspective view of the heater 206. In an embodiment, the heater 206 includes a casing 250 and a heat generation unit 252 housed within the casing 250. In the illustrated embodiment, the heat generation unit 252 is embodied as an electrical coil heater having a serpentine configuration. Other heaters known to a person skilled in the art may be implemented. An electrical input unit 254, extending from the casing 250, is electrically connected to the heat generation unit 252. The electrical input unit 254 includes, for example, electrical pins 256 configured to power the electrical generation unit 252. According to an aspect of the present disclosure, the heater 206 may be powered via an in-oven plug, thereby eliminating a requirement of independent power lines to be routed through the cabinet of the oven 100 for the purpose of powering the heat generation unit 252. In some embodiments, the housing 202 may define a port (not shown) through which the electrical input unit 254 may extend when the heater 206 is disposed within the housing 206. For example, the heater 206 may be placed within the housing 206 and may be positioned appropriately such that the electrical input unit 254 extends out of the housing 206, through the port, to aid connection with the in-oven plug extending through the cooking chamber 102. It will be understood that a periphery of the port described herein and other coupling elements which may be disposed within the cooking chamber 102 may be coated with heat-resistant materials to safeguard the electrical components.

FIG. 2C illustrates a perspective view of the container 208, according to an embodiment of the present disclosure. The container 208 includes a cavity 260 configured to receive wood (flavored or natural) or coal pellets (together referenced with numeral 262) or a combination thereof. In an aspect, a lid 264 of the container 208 is perforated. Particularly, the lid 264 defines an array of through holes 268 extending through a thickness thereof. The container 208 may include a heat-conducting surface 270 at a base thereof. In an installed condition of the food smoking device 124, the container 208 is disposed on the heater 206, where the heat-conducting surface 270 is configured to receive heat from the heat generating unit 252. Further, the heat-conducting surface 270 is configured to heat the wood or coal pellets 262 contained in the cavity 260.

In operation, the heater 206 and the container 208 are suitably disposed within the housing 202 as described hereinabove. With the electrical supply, the heater 206 heats the wood or coal pellets 262 contained in the container 208, to generate smoke which escapes into the smoke-collecting chamber 210 through the holes 268 defined in the lid 264. Since the pipe 204 fluidly connects the smoke-collecting chamber 210 and the cooking chamber 102 of the oven 100, the generated smoke flows into the cooking chamber 102 to flavor the food “F” (see FIG. 2A) placed on the rack 116 of the oven 100. During the flow through the pipe 204, the generated smoke loses heat to form cold smoke. In some embodiments, the user may be allowed to choose a type of smoking, such as hot smoking or cold smoking. For the purpose of hot smoking, the food may be cooked and smoked simultaneously. The generated smoke may be heated within the cooking chamber 102 with the aid of components of the oven 100, such as a heater used for baking and grill cooking mode. In some embodiments, the smoke may be allowed to rest in the cooking chamber 102 until the food is smoked to a desired level. Upon completion of the cooking cycle, the suction fan 212 is actuated to create a suction force to selectively extract the smoke into the smoke-collecting chamber 210. It will be understood that the electrical supply to the heater 206 may be stopped once the cooking cycle is completed. Preferably, the suction fan 212 may be operated for a predetermined time period, for example few seconds, after the completion of the cooking cycle to ensure that all the smoke present in the cooking chamber 102 is extracted into the smoke-collecting chamber 210.

To this end, the present disclosure provides the food smoking device 124 that help users to smoke or flavor foods in domestic ovens, thereby improving taste and shelf life of the food. With simple construction and minimal efforts required to perform the assembly, the food smoking device 124 simplifies food-smoking processes, thereby helping users to smoke the food inside a kitchen and eliminate a requirement for a garden barbecue apparatus or other professional units which demands space due to their size. Advantageously, owing to the presence of the suction fan 212, the food smoking device 124 is capable of preventing residual smoke, such as smoke clouds and odors, within the cooking chamber 102 upon completion of the cooking cycle set by the user. As such, the user may not witness the smoke clouds and may have a clear view of the cooking chamber 102 when the door of the oven 100 is actuated to the open position to access the food prepared within the oven 100, thereby enhancing the user's experience.

After the food-smoking process, the food smoking device 124 may be removed from the cooking chamber 102 and the wood or coal pellets 262 contained in the cavity 260 of the container 208 may be emptied into the trash. Since the wood chips and the coal pellets are commonly known materials and are not heated to very high temperatures, disposal of the same does not require special procedures to be followed. Owing to the size and minimum space requirement, the food smoking device 124 and the components thereof may be conveniently stored anywhere in a kitchen area. In some embodiments, the housing 202, the heater 206, the container 208, and the pipe 212 may be made up of similar heat-resistant materials, such as stainless steel, nickel-based alloys, other known alloys, or suitable combinations thereof. Heat resistance properties of such materials may allow restoration of the food smoking device 124 in the cooking chamber 102 without the need to cool down the oven 100 after completion of the cooking cycle.

The container 208 may be cleaned manually with a tissue or common paper products for cleaning (for example paper towels and napkins). Since the food smoking device 124 may only be soiled by particles of smoke, a requirement for frequent cleaning upon completion of each food-smoking process may be eliminated. Instead, the food smoking device 124 may be cleaned sporadically, when desired, with a light paper product. Alternatively, the components of the food smoking device 124 may be cleaned in a dishwasher.

While aspects of the present disclosure have been particularly shown and described with reference to the embodiments above, it will be understood by those skilled in the art that various additional embodiments may be contemplated by the modification of the disclosed methods without departing from the spirit and scope of what is disclosed. Such embodiments should be understood to fall within the scope of the present disclosure as determined based upon the claims and any equivalents thereof.

1. A food smoking device for an oven, comprising:
a housing removably disposed within the oven, the housing defining an opening;
a heater disposed within the housing;
a container removably disposed on the heater and configured to receive wood or coal pellets, wherein a lid of the container is perforated, and
wherein the housing defines a smoke-collecting chamber therein, the smoke-collecting chamber configured to (a) receive, via the perforated lid of the container, smoke generated from heated wood or coal pellets; (b) fluidly communicate with a cooking chamber of the oven via the opening of the housing, and (c) supply the generated smoke into the cooking chamber; and
a suction fan disposed within the housing and configured to selectively extract smoke into the smoke-collecting chamber.

2. The food smoking device of claim 1, further comprising a pipe extending from a periphery of the opening in the housing, wherein the pipe is configured to route the smoke from the smoke-collecting chamber to the cooking chamber.

3. The food smoking device of claim 1, wherein the heater is powered by an in-oven plug.
